(19) United States
(12) Patent Application Publication
(10) Pub. No.: US 2007/0041036 A1
(43) Pub. Date: Feb. 22, 2007

(54) Image forming apparatus

(75) Inventor: Fumiharu Nakayama, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/206,175

(22) Filed: Aug. 18, 2005

(51) Int. Cl. G06F 3/12

(52) U.S. Cl. 358/1.15; 358/1.13; 358/448

(57) ABSTRACT

In a digital multi-function peripheral, a network button (Available Network) is provided on a liquid crystal display section of an operator panel. When a user presses a currently available network button, a wireless communication control unit provides a main CPU 10 with an SSID that is used in a connectable wireless device (access point), along with a wireless mode, a channel and an RSSI. The main CPU causes the liquid crystal display section of the operator panel to display the RSSI value that is provided from the wireless communication control unit.

### BACKGROUND OF THE INVENTION

1. Field of the Invention

The present invention relates to an image forming apparatus, such as a digital multi-function peripheral (MFP), which has a wireless LAN function, and to a wireless communication control method.

2. Description of the Related Art

In recent years, with development of wireless LANs, there is such a problem that neighboring wireless LAN systems interfere with each other. It is thus important to provide a countermeasure to the problem, such as recognition of the communication condition (sensitivity), on the apparatus side of, e.g. a digital multi-function peripheral (MFP).

However, the image forming apparatus, such as MFP, is not provided with a countermeasure, such as indication of communication sensitivity of a wireless LAN. In other words, the image forming apparatus has no means for providing an optimal installation condition for communication with an opposed wireless device (e.g. access point).

Further, at present, no means is provided for notifying a wireless LAN network user of deterioration (temporary or continuous) in communication sensitivity due to external factors.

As has been described above, the conventional MFP has no function, on the MFP side, for displaying a detailed reception sensitivity. It is thus impossible to constitute an optimal communication condition for communication with an access point. Further, no countermeasure has been taken in consideration of the interference with other wireless devices or the effect in the ambient environment of the MFP (e.g. the material of the wall of the location where the MFP is installed, the distance from the wall, or other factors that may lead to ratio wave interference with opposed devices).

Besides, in the case of the MFP, there is such a problem that, for example, even if the communication condition at the time the MFP was installed was proper, it is very difficult to understand subsequent degradation in the communication environment due to external factors.

### BRIEF SUMMARY OF THE INVENTION

The object of an aspect of the present invention is to provide an image forming apparatus and a wireless communication control method, which can optimize the condition for installation in relation to an access point or some other wireless device.

According to an aspect of the present invention, there is provided an image forming apparatus that has a function for communication with an external device and forms an image, comprising: wireless communication control means for controlling wireless communication; acquisition means for acquiring a value of reception sensitivity with the external device, using the wireless communication control means; and display means for displaying the reception sensitivity value, which is acquired by the acquisition means.

According to another aspect of the present invention, there is provided a wireless communication control method for an image forming apparatus that has a function for communication with an external device and forms an image, comprising: acquiring a value of reception sensitivity with the external device, with wireless communication being controlled; and displaying the acquired reception sensitivity value.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 shows an external structure of a digital multi-function peripheral according to an image forming apparatus of the present invention;

FIG. 2 is a block diagram that schematically shows the structure of a digital multi-function peripheral;

FIG. 3 shows an example of display of settings, which are displayed on a liquid crystal display section in order to indicate a communication environment;

FIG. 4 shows examples of RSSI values, which are displayed on the liquid crystal display section;

FIG. 5 shows an example of radiation characteristics of an antenna in an anechoic room at a time the antenna is mounted on the MFP; and

FIG. 6 shows a standard wireless LAN connection environment in an infrastructure mode.

### DETAILED DESCRIPTION OF THE INVENTION

An embodiment of the present invention will now be described with reference to the accompanying drawings.

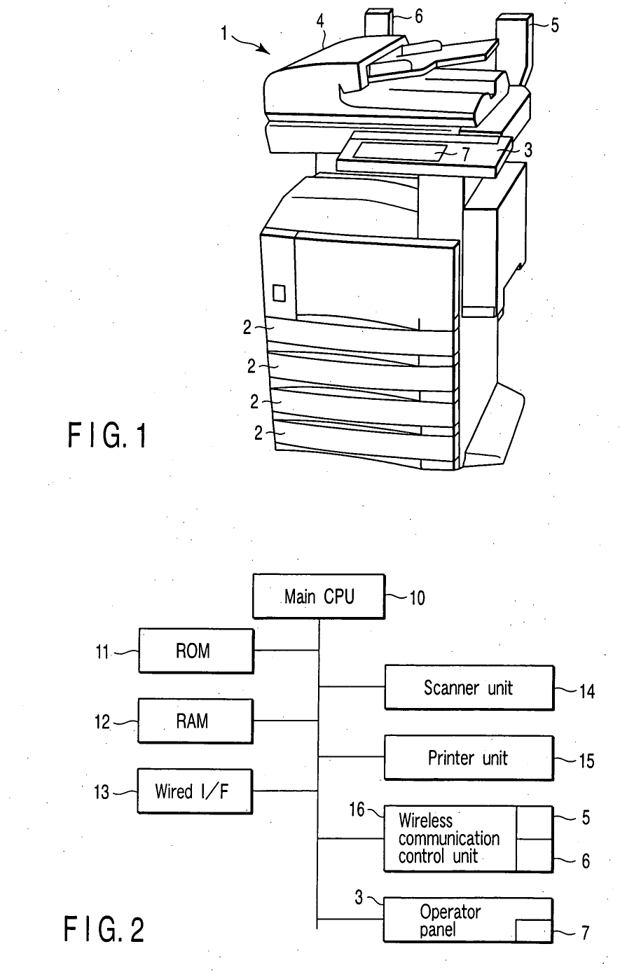

FIG. 1 shows an external structure of a digital multi-function peripheral (MFP) according to an image forming apparatus of the present invention. Specifically, the MFP 1 includes a plurality of sheet-feed cassettes 2 at a lower front part thereof, and an operator panel 3 at an upper front part thereof. An automatic document feeder (RADF) 4 is mounted on an upper part of the MFP 1. In addition, a main antenna 5 and a sub-antenna 6 are provided on the rear side of the MFP 1. The main antenna 5 and sub-antenna 6 are composed of, e.g. dual-band antennas. Further, the operator panel 3 is provided with a liquid crystal display section 7.

FIG. 2 schematically shows the structure of the MFP 1. The MFP 1 comprises a main CPU 10 that executes an overall control; a ROM 11; a RAM 12, a wired interface (I/F) 13 for wired connection; a scanner unit 14; a printer unit 15; a wireless communication control unit 16 that controls wireless communication; and the above-mentioned operator panel 3 with the liquid crystal display section 7. The above-mentioned main antenna 5 and sub-antenna 6 are connected to the wireless communication control unit 16.

The MFP 1 has a standard structure in which the scanner unit 14 is input means for inputting an image on an original, and the printer unit 15 is output means for executing print-out.

Next, the outline of the present invention with the above-described structure is described.

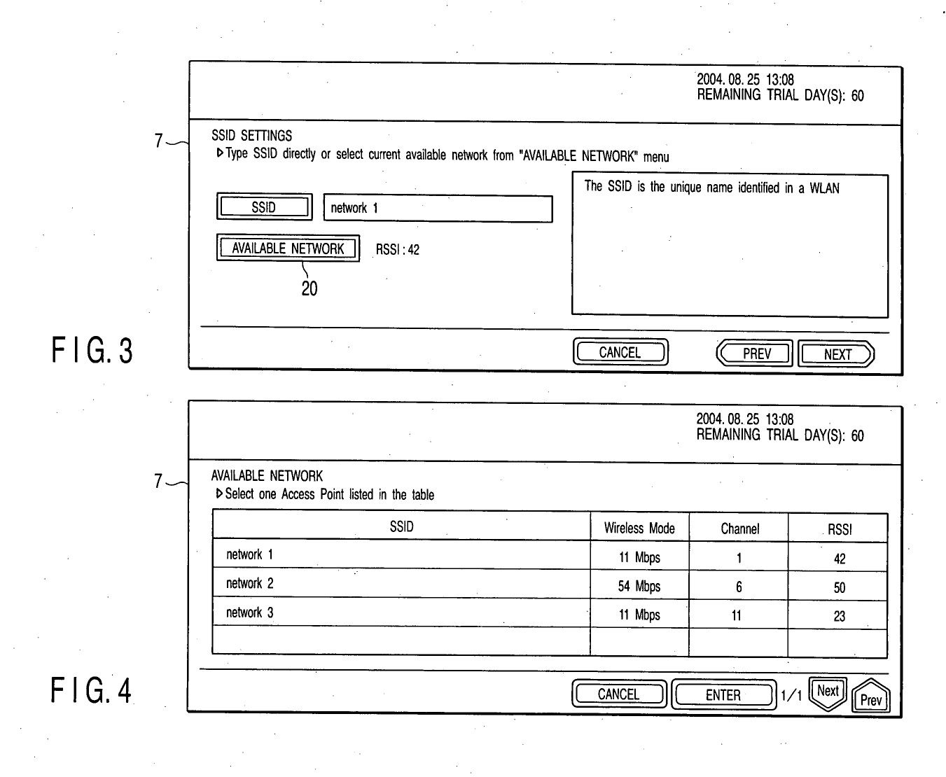

FIG. 3 shows an example of display of settings, which appears on the liquid crystal display section 7 of the operator panel 3 and displays a communication environment relating to the present invention. In the example displayed on the liquid crystal display section 7, a network button (Available Network) 20 is provided.

To begin with, when the user presses the currently available network button (Available Network) 20, the wireless communication control unit 16 provides the main CPU 10 with an SSID (Service Set Identification) that is used in a connectable wireless device (access point), along with a wireless mode, a channel and an RSSI (Receive Signal Strength Indication) value.

The main CPU 10 causes the liquid crystal display section 7 of the operator panel 3 to display the RSSI value that is provided from the wireless communication control unit 16. The RSSI value is displayed in real time, where necessary.

FIG. 4 shows examples of RSSI values that are displayed on the liquid crystal display section 7. As is shown in FIG. 4, for example, a network 1 of the SSID has a wireless mode of 11 Mbps, a channel 1, and an RSSI value of 42.

A network 2 of the SSID has a wireless mode of 55 Mbps, a channel 6, and an RSSI value of 50.

A network 3 of the SSID has a wireless mode of 11 Mbps, a channel 11, and an RSSI value of 23.

In the present invention with the above-described structure, it is thought that the reception sensitivity increases as the RSSI value takes a highest value. It is possible to designate (adjust), with reference to the RSSI value, the optimal place for installation in the environment of installation, the direction of the MFP 1, and the angle (antenna disposition angle condition).

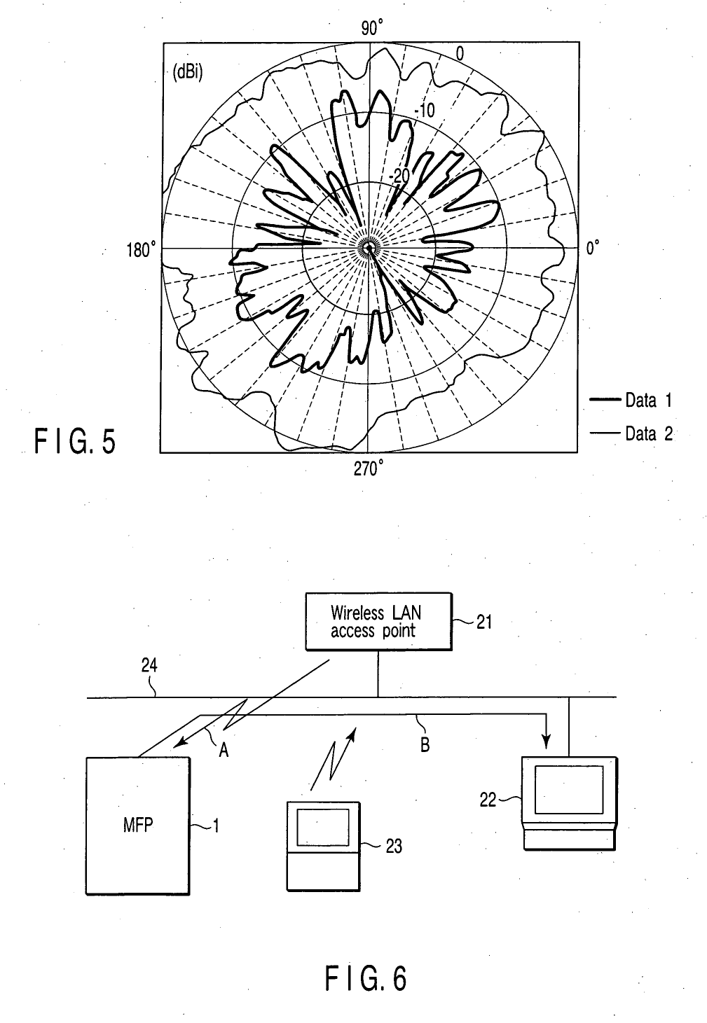

FIG. 5 shows an example of radiation characteristics (non-uniform over 360°) of antennas (5, 6) in an anechoic room at a time the antennas are mounted on the MFP 1. Data 1 indicates radiation characteristics in the horizontal direction, and Data 2 indicates radiation characteristics in the vertical direction. The front side of the MFP 1 is set at 0°, the right side of the MFP 1 is set at 90°, the rear side of the MFP 1 is set at 180°, and the left side of the MFP 1 is set at 270°. Based on this setting, the radiation characteristics of the antenna (5, 6) are indicated.

As regards the condition of installation of the MFP 1, it is understood that degradation occurs in the antenna sensitivity in (specific) directions in the range of 280° to 320°. That is, it is understood that as regards the condition for installing the MFP 1, the distance for installation from the access point and the angle of disposition of the antennas provided on the MFP 1 are necessary for constituting a good communication environment.

On the other hand, it is thought that after the installation of the MFP 1, if a consideration change occurs in the communication environment (e.g. when a partition is unexpectedly provided near the antenna, when a metallic shelf is disposed, when interference occurs with some other wiring device, or when the MFP 1 is moved), it is necessary to notify the administrator of a problem, if any.

This is because the user does not easily recognize that the wireless LAN is a communication scheme using an antenna radiation power, unlike the wired LAN, and thus the wireless LAN is susceptible to the above-mentioned external factors. That is, the user tends to erroneously believe that the initially set communication environment would not change subsequently. There may be a case where the user does not understand at all the situation in which degradation in communication speed occurs due to the above conditions on the MFP 1 side and the access point side.

In the present invention, the administrator is quickly informed of a change in the wireless LAN communication environment.

To begin with, as means for discriminating a reception sensitivity problem of a predetermined level, the main CPU 10 periodically acquires data relating to the reception sensitivity at a predetermined past time, thereby collecting reception sensitivity data on a time-by-time basis.

In the present invention, a value (reference value) of reception sensitivity, which is obtained at a time of initial installation setting, is stored as an optimal value (expected value). A subsequent variation in reception sensitivity is periodically monitored, and if an abrupt change (degradation) in RSSI value occurs, the use is informed of the occurrence of a wireless LAN radio wave problem over the wired LAN.

For example, assume that that the value of RSSI is defined in a range of 1 to 100, and a read mean value of RSSI at the time of installation is 80 (recommended value). In this case, a normal value is set at 50 or less, for instance. The main CPU 10 executes continuous sampling (e.g. every 5 minutes). If the RSSI takes abnormal values consecutively, an alert is issued to the user.

The selection range (numeral value setting) in this case can arbitrarily be set, which characterizes the invention.

Past RSSI values can be confirmed (for reference). Thus, a time-series variation in communication environment in the past can be understood.

A supplementary explanation of the RSSI value will now be given.

In general, recommended values are set for RSSI. For example, the recommended value is set at 80 or more. As the value decreases, the possibility of communication fault increases. However, the wireless communication control unit includes means for coping with degradation in communication environment by decreasing the transfer rate. The present invention mainly aims at achieving communication environment matching, and maintaining a higher transfer rate.

FIG. 6 shows a standard wireless LAN connection environment in an infrastructure mode. Referring to FIG. 6, a notification system relating to degradation in RSSI value is explained.

The wireless LAN connection environment comprises an MFP 1, a wireless LAN access point 21, an administrator personal computer (PC) 22, a wireless LAN terminal 23, and a wired LAN 24.

The wireless LAN terminal 23 is a personal computer that is used by a general wireless LAN user. The wireless LAN terminal 23 is connected to the wired LAN (wired backbone) 24 via the wireless LAN access point 21. Similarly, the MFP 1 is wirelessly LAN-connected via the wireless LAN access point 21. The administrator PC 22 is connected to the wired LAN (wired backbone) 24 by wired connection. The administrator PC 22 may not necessarily be connected by wired connection.

A notification sequence in the above-described structure is described.

As has been described above, if communication sensitivity A for communication between the wireless communication control unit 16 and the wireless LAN access point 21 decreases below a preset value, the main CPU 10 of the MFP 1 sends a message to the administrator PC 22 via a failure notification path B, thus giving a notice on the communication failure.

As has been described above, according to the embodiment of the invention, the digital multi-function peripheral (MFP) is provided with a function for displaying detailed RSSI values (reception sensitivity). Thereby, the MFP can be installed in a proper installation condition.

In addition, since the digital multi-function peripheral (MFP) is provided with the failure notification function, it becomes possible to quickly recognize an unintentional change in environment, and to have an opportunity for taking a quick measure.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus that has a function for communication with an external device and forms an image, comprising:
wireless communication control means for controlling wireless communication;
acquisition means for acquiring a value of reception sensitivity with the external device, using the wireless communication control means; and
display means for displaying the reception sensitivity value, which is acquired by the acquisition means.

2. The image forming apparatus according to claim 1, wherein the acquisition means acquires an RSSI value.

3. The image forming apparatus according to claim 1, wherein the display means displays in real time the reception sensitivity value, which is acquired by the acquisition means.

4. An image forming apparatus that has a function for communication with external devices including an administrator, and forms an image, comprising:
wireless communication control means for controlling wireless communication;
acquisition means for acquiring a value of reception sensitivity with the external device, using the wireless communication control means;
comparison means for presetting a reference value in relation to the reception sensitivity value, which is acquired by the acquisition means, and comparing the preset reference value and the reception sensitivity value, which is acquired by the acquisition means; and
notification means for giving a notice to the administrator when a comparison result of the comparison means shows that the reception sensitivity value is lower than the reference value.

5. The image forming apparatus according to claim 4, wherein the reference value is a reception sensitivity value, which is acquired by the acquisition means at a time the image forming apparatus is installed.

6. The image forming apparatus according to claim 4, wherein the reference value is an arbitrarily preset value.

7. The image forming apparatus according to claim 4, wherein the notification means gives notification to the administrator that is connected in advance to the image forming apparatus by wired connection.

8. The image forming apparatus according to claim 4, wherein the notification means gives notification to the administrator via the wireless communication control means of the image forming apparatus.

9. A wireless communication control method for an image forming apparatus that has a function for communication with an external device and forms an image, comprising:
acquiring a value of reception sensitivity with the external device, with wireless communication being controlled; and
displaying the acquired reception sensitivity value.

10. A wireless communication control method for an image forming apparatus that has a function for communication with external devices including an administrator, and forms an image, comprising:
acquiring a value of reception sensitivity with the external device, with wireless communication being controlled;
presetting a reference value in relation to the acquired reception sensitivity value;
comparing the preset reference value and the acquired reception sensitivity value; and
giving notification to the administrator when a comparison result shows that the reception sensitivity value is lower than the reference value.
